(19) United States
(12) Patent Application Publication
(10) Pub. No.: US 2008/0011941 A1
(43) Pub. Date: Jan. 17, 2008

(54) Aviation night vision system using common aperture and multi-spectral image fusion

(75) Inventors: Michael E. Couture, Litchfield, NH (US); Vadim Plotsker, Amherst, NH (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: OASYS Technology LLC, Manchester, NH (US)

(21) Appl. No.: 11/271,482

(22) Filed: Nov. 11, 2005

Related U.S. Application Data
(60) Provisional application No. 60/627,116, filed on Nov. 12, 2004.

(51) Int. Cl. H01J 43/30; H01J 31/50

(52) U.S. Cl. 250/214 VT

(57) ABSTRACT

An multispectral optical device, comprising a common aperture objective assembly for image acquisition in the short wave infrared (SWIR) waveband and at least one additional waveband; a SWIR detector for detecting an image in the SWIR waveband; and a beam mixer for fusing an image detected by the SWIR detector and an image acquired in the at least one additional waveband.

### RELATED APPLICATIONS

This application is related to U.S. application Ser. No. 11/176,690, filed Jul. 7, 2005. This application claims the benefit of U.S. Provisional application No. 60/627,116, filed Nov. 12, 2004. The entire teachings of the above applications are incorporated herein by reference.

### GOVERNMENT SUPPORT

The invention was supported, in whole or in part, by a grant FA8650-05-C-6507 from the U.S. Air Force. The Government has certain rights in the invention.

### BACKGROUND OF THE INVENTION

Optical sensors and detectors, including night vision systems, often use multiple imaging channels, each operating at a specified waveband. Standard night vision is enhanced with the addition of an infrared (IR) channel. Typical night vision systems operate in the 0.6 to 0.9 μm spectral waveband. These devices use image intensifier tubes to amplify ambient light not normally visible to the human eye and form an image on a phosphor screen that emits visible (usually green) light.

However, typical IR night vision devices cannot be used by aircraft crew because the canopy and windows of an aircraft are opaque in the thermal infrared wavebands. Furthermore, typical infrared night vision devices do not have sufficient resolution and sensitivity to detect objects hidden under camouflage, to view laser wavelengths commonly used for target designation and for rangefinders or to see through atmospheric obscurants, such as fog.

### SUMMARY OF THE INVENTION

There is a need for an optical multi-waveband compact and lightweight system that solves the problem of the insufficient sensitivity of conventional IR sensors. There is further a need for a system that is compact, e.g. a common aperture system, and lightweight, e.g. hand-held or head-mounted. There is further a need for a night vision optical system that allows an aircraft crew to see through the canopy and windows, which are opaque in the thermal infrared wavebands.

Accordingly, in one embodiment, the present invention is a multispectral optical device comprising a common aperture objective assembly for image acquisition in the short wave infrared (SWIR) waveband and at least one additional waveband; a SWIR detector for detecting an image in the SWIR waveband; and a beam mixer for fusing an image detected by the SWIR detector and an image acquired in the at least one additional waveband.

In another embodiment, the present invention is a night vision system, comprising means for acquiring a multi-spectral image through a common aperture; means for converting a short wave infrared (SWIR) portion of the acquired image into the visible waveband, thereby generating a converted image; means for fusing the converted image with at least one additional portion of the acquired image.

In another embodiment, the present invention is a method of displaying images, comprising acquiring a multi-spectral image through a common aperture; converting a short wave infrared (SWIR) portion of the acquired image into the visible waveband, thereby generating a converted image; and fusing the converted image with at least one additional portion of the acquired image.

Further facilitating its use in aviation, a system employing short wave IR sensors allows a user to view laser wavelengths commonly used for target designation (1.06 μm) and for rangefinders (1.5 μm). Additionally, the short wave IR band is less sensitive to transmission loss through the atmosphere due to particulate scatter (water droplets, clouds, dust, fog, etc.)

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of an embodiment of the present invention.

FIG. 2 is a schematic diagram of an alternative embodiment of the present invention.

FIG. 3A is an exploded view of an embodiment of the present invention.

FIG. 3B is a side view of an embodiment of the present invention shown in FIG. 3A.

FIGS. 4A and 4B are illustration of one use of the device shown in FIGS. 3A and 3B.

FIG. 5 depicts an exemplary complete field of view, as seen by an observer, of the device shown in FIGS. 3A, 3B.

FIG. 6 is a plot of output power of a device of shown in FIGS. 3A and 3B as a function of wavelength.

FIG. 7 is a plot of reflectivity as a function of wavelength for different types of camouflage netting and green vegetation.

FIGS. 8A and 8B are photographs of a camouflage vest taken in visible waveband (FIG. 8A) and by using an SWIR detector employed by the device of the present invention (FIG. 8B).

FIGS. 9A and 9B are photographs of landscape covered in mist taken in visible waveband (FIG. 9A) and by using an SWIR detector employed by the device of the present invention (FIG. 9B).

### DETAILED DESCRIPTION OF THE INVENTION

A description of preferred embodiments of the invention follows.

The present invention is a common aperture, multi-spectral night vision system that provides a fusion of at least two images: one, originating from an image intensified (I²) optical channel and at least one other image originating in a spectral channel operating in a near infrared band (NIR, approximately 0.9 μm to 1.9 μm) that includes a short wave infrared (SWIR) range of wavelengths from about 1.0 μm to about 1.8 μm. In a preferred embodiment, the night vision (NV) system provides a fused, spatially registered (overlayed on top of each other) imaging. Preferably, one of the spectral channels is a visible image intensifier channel (I²) operating in the range of wavelengths from about 0.6 μm to about 0.9 μm.

In the description below, the terms “NIR” and “SWIR” are used interchangeably as a matter of convenience. It is understood that the present invention can operate in the NIR range. It is further understood that the preferred sensitivity of the NIR detectors is from about 0.9 μm to about 1.8 μm.

As used herein, the term “detector” refers to any one or more elements that receives an image in the visible, infrared or other part of optical spectrum and manipulates and/or transforms this image by amplifying its intensity or converting it to the visible spectrum. As used herein, the term “lens element” refers to one or more elements having optical power, such as lenses, that alone or in combination operate to modify an incident beam of light by changing the curvature of the wavefront of the incident beam of light. A “display” can be any surface used to produce a wavefront encoding an image. Examples of displays include CRT-based, LCD-based or gas-plasma-based flat panel displays. In one embodiment, a display can be a projection screen. As used herein, the term “beam” refers to one or more rays.

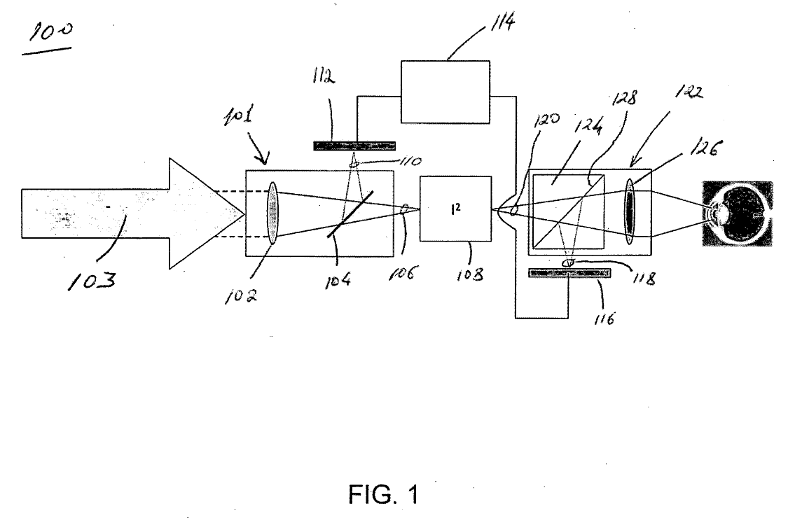

A conceptual diagram of the invention is illustrated in FIG. 1. The night vision system 100 includes a common aperture objective assembly 101. Common aperture objective assembly 101 includes a common aperture lens 102 and a dichroic beamsplitter 104. Multi-spectral beam 103 is captured by common aperture objective assembly 101 and is directed by one or more lens elements 102 toward beamsplitter 104. Even though FIG. 1 depicts a single lens 102, one skilled in the art would understand that one or more lens element, as defined above, can be used in objective assembly 101.

Beamsplitter 104 causes beam 103 to be separated into a short wave infrared (SWIR) waveband portion 110 and at least one beam 106. In the embodiment shown in FIG. 1, beam 106 is a visible waveband portion of beam 103.

Following beamsplitter 104, beam 106 is incident on image intensifier tube 108, where the signal is amplified (spectral waveband 0.6-0.91 μm, in general).

Similarly, beam 110 is reflected by beamsplitter 104 to focal plane array 112. One skilled in the art understands that FPA detectors include standard electronic components required for processing the detected images.

Focal plane arrays capable of detecting the NIR waveband, including SWIR, can be any commercially available SWIR detector. Preferably, focal plane array 112 includes InGaAs semiconducting material. Examples of commercially available SWIR detectors are the SUI™, sold by Sensors Unlimited, Inc. of Princeton, N.J.

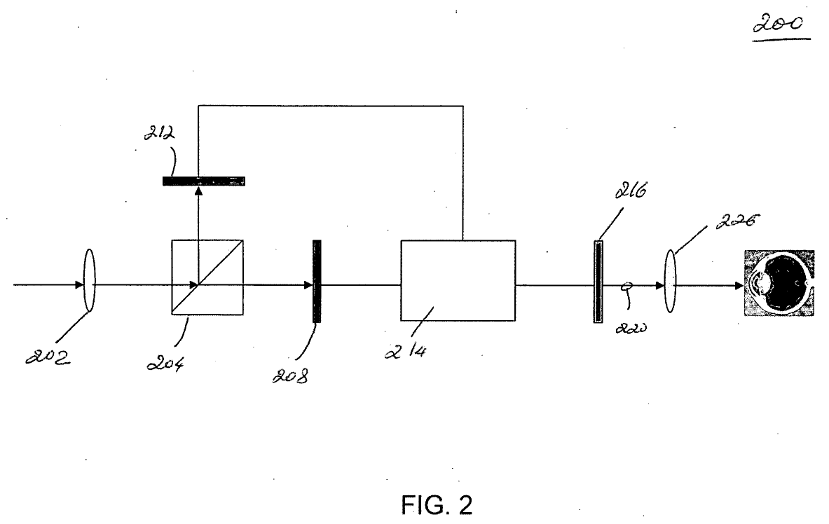

The signal detected by focal plane array 112 is processed, if required, by optional programmable CPU 114 and then displayed on display 116. Display 116 is preferably a visible organic light emitting diode (OLED) microdisplay. Beam 118 from display 116 and beam 120 from the phosphor surface of image intensifier tube 108 are combined into a single image in eyepiece assembly 122. Eyepiece assembly 122 includes beam mixer 124 and lens 126 in an arrangement similar to that used in the objective assembly 101. Preferably, beam mixer 124 is a beamsplitter. Other embodiments of beam mixers can be used, as will be described below with reference to FIG. 2. Even though FIG. 1 depicts a single lens 126, one skilled in the art will understand that one or more lens elements can be used in eyepiece assembly 122. Combining surface 128 of beamsplitter 124 is coated by a dichroic coating to efficiently transmit the narrow phosphor spectrum, while reflecting all other portions of the visible spectrum to view the OLED microdisplay, such as display 116.

In an alternative embodiment, image intensifier tube 108 can be replaced by an additional FPA detector (not shown). In this embodiment, an additional display, driven by an electrical signal generated by the additional FPA detector can be placed adjacent to beam mixer 124. Beam splitter 124 will fuse the beams generated by display 116 and the additional display.

An alternative embodiment of the invention is device 200 shown in FIG. 2. In this embodiment, the image intensifier tube shown in FIG. 1 as element 108, is replaced by FPA detector 208. Referring to FIG. 2, in this embodiment, the device of the invention includes at least one objective lens 202, beamsplitter 204, SWIR focal plane array 212 and an additional focal plane detector (FPA) detector 208 that replaces image intensifier tube shown in FIG. 1 as element 108. The embodiment of FIG. 2 includes a single display 216. Display 216 is driven by an electrical signal generated by programmable CPU 214. CPU 214 digitally fuses images encoded by the electrical signals generated by FPA detectors 208 and 212. Thus, in this embodiment, CPU 214 and display 216 perform the function of a beam mixer. Fused image beam 220, generated by display 216, is directed through at least one lens 226 into an eye of an observer. Selection and implementation of an algorithm for digitally fusing images is well within the knowledge of one of ordinary skill in the art.

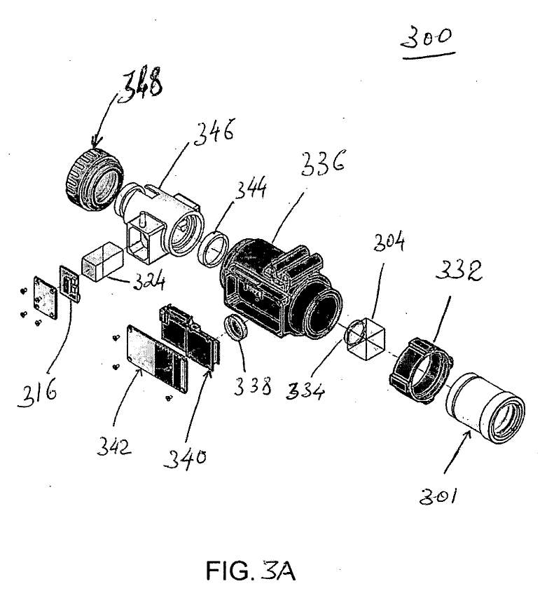

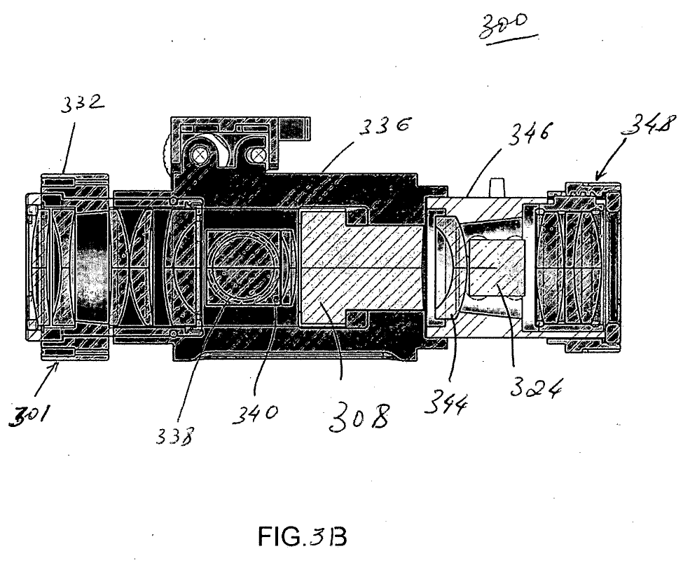

A preferred embodiment of a device of the present invention is shown in FIG. 3A (exploded view) and FIG. 3B (side view).

Device 300 includes objective focusing cell 301, housing 336, eyepiece housing 346 and eyepiece diopter cell 348. Objective focusing cell 301 includes focus ring 332 for adjusting the focal length of cell 301. Similarly to device 100, shown in FIG. 1, device 300 includes first beamsplitter 304, disposed within housing 336. A beam that passes through first beamsplitter 304 is split, and a first portion of the beam continues through first objective field lens 334 toward image intensifier tube 308, while a second portion of the beam is diverted through second objective filed lens 338 to SWIR detector 340. Image intensifier tube 308, SWIR detector 340 as well as SWIR-detector-associated electronics 342 are disposed within housing 336.

The image-intensified beam continues through additional lens 344 toward second beamsplitter 324, which fuses the image carried by the image-intensified beam and the image produced by display 316, which is driven by an electrical signal generated by SWIR detector 340. The fused image is viewed by an observer through eyepiece diopter cell 348. Second beamsplitter 324 and display 316 are disposed within eyepiece housing 346.

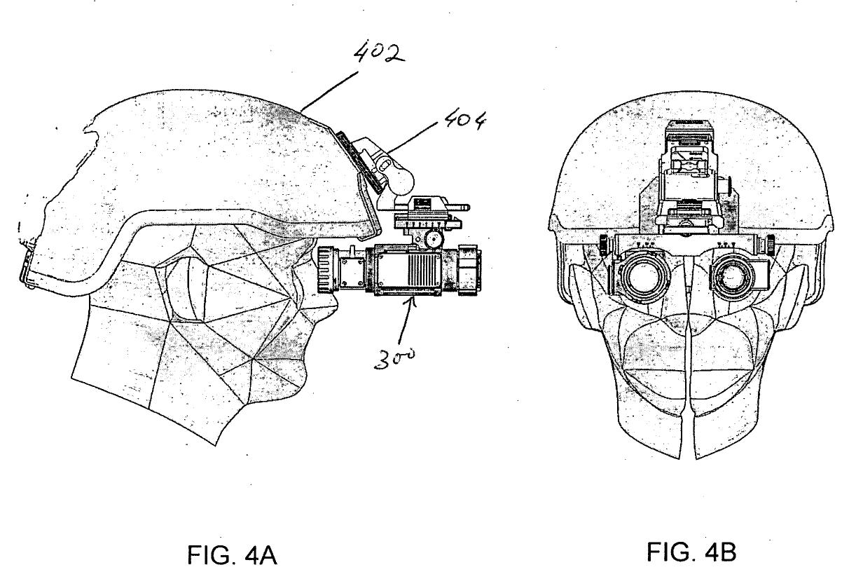

A preferred use of device 300 is shown in FIGS. 4A and 4B. These figures show that at least one device 300 can be mounted on helmet 402 using conventional mounting clip 404. Two devices 300 can be used to achieve stereo vision.

### EXEMPLIFICATION

### Example 1

### System Parameters

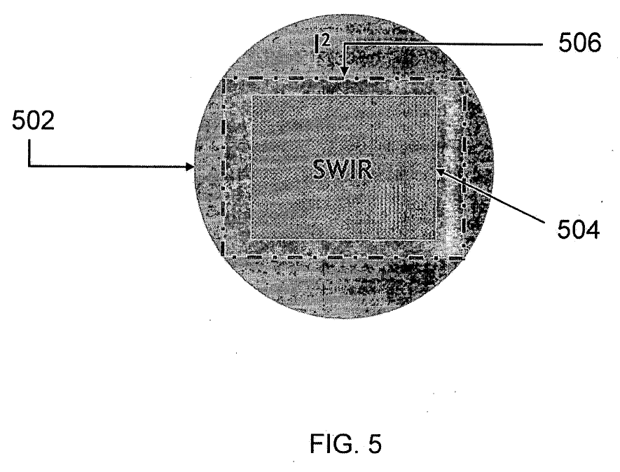

FIG. 5 depicts an exemplary complete field of view, as seen by an observer, of device 300 shown in FIGS. 3A, 3B, 4A and 4B.

Field 502 represents the field of view (FOV) of image intensifier tube 308 (I² channel). In this example, the FOV for the I² channel is 36-40 degree at greater than 1.4 cycles per mrad.

Field 504 represents the FOV for commercially available SWIR detectors, which typically have 320×240 pixels and a 25 micron pitch (the distance between adjacent pixels). The FOV for this type of a SWIR detector is 22.5-25 degrees at 0.5 cycles per mrad. (Instantaneous FOV=1 mrad for 25 μm pitch).

Field 506 represents the FOV for SWIR detectors, which typically have 320×240 pixels at 40 micron pitch. The FOV for this type of a SWIR detector is 36 degree for 0.315 cycles per mradian. (IFOV=0.63 mrad; 40 μm pitch).

### Example 2

### Performance of the Device of the Present Invention

A device of the present invention, such as device 300 shown in FIGS. 3A, 3B, 4A and 4B, has a number of advantages over currently used night vision devices.

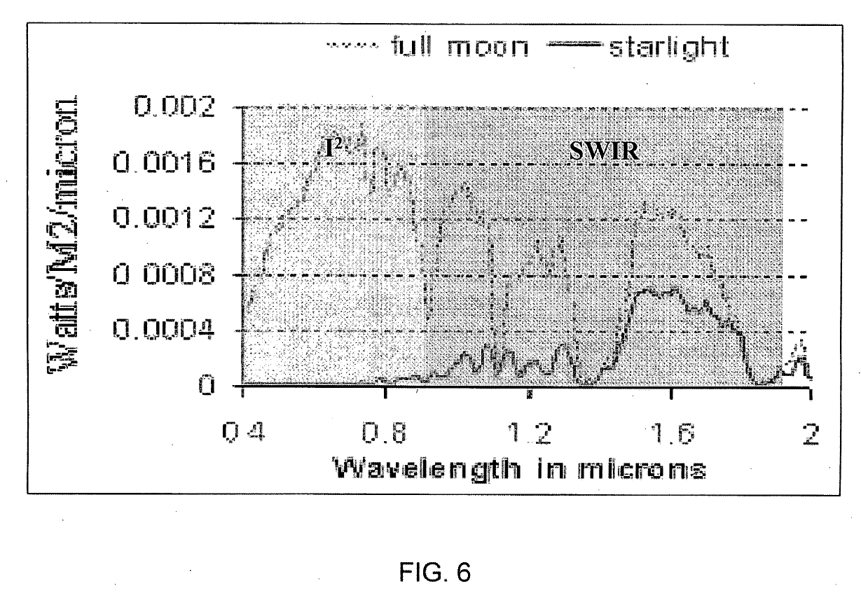

Device 300 provides a reliably sufficient output under very low ambient light, such as, for example, star light. The plots presented in FIG. 6 compare the performance of device 300 under either moon light or star light.

While image intensifiers of device 300 amplify ambient light, the longer wavelengths of the SWIR spectrum enable significant gain in starlight conditions as well as detection of thermal emission of hot objects.

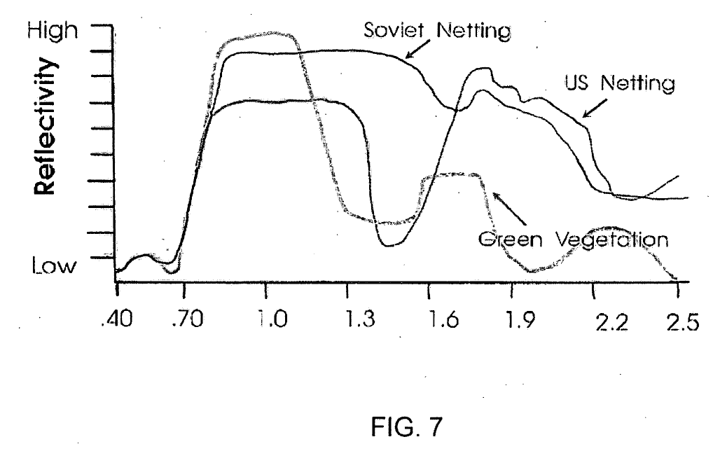

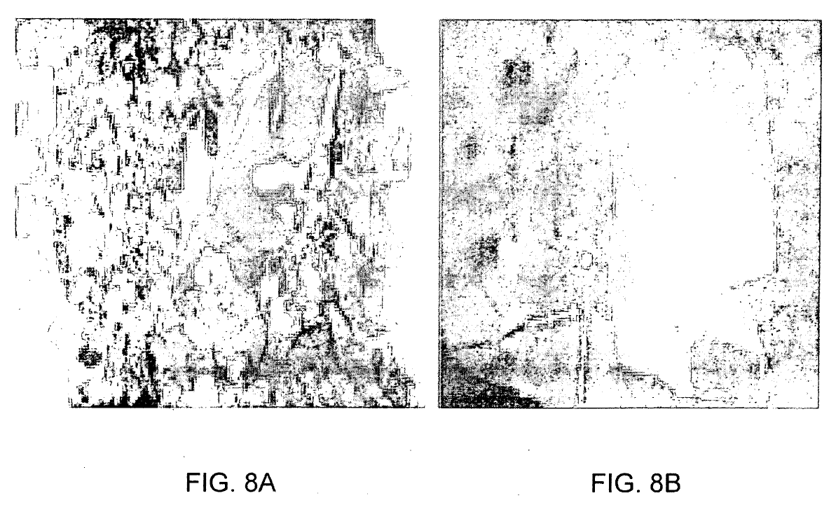

Due to the inherent change in reflectance of many natural materials, device 300 is very effective for detection of objects hidden under camouflage. FIG. 7 illustrates the reflectivity as a function of wavelength of camouflage netting used by either former Soviet Union military or by the U.S. military and compares these reflectivity curves to the reflectivity of green vegetation. FIGS. 8A and 8B are side-by-side photographs of a camouflage vest hidden inside foliage and viewed through a visible camera (8A) and viewed by a SWIR camera (8B). As can be seen the SWIR camera can easily distinguish camouflage from foliage where as the visible camera can not.

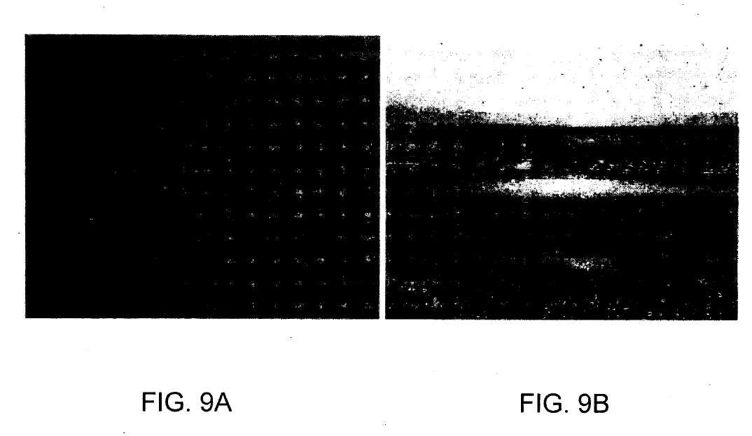

Yet another advantage of device 300 is its ability to see through fog and other atmospheric obscurants, as illustrated by FIGS. 9A and 9B. FIGS. 9A and 9B are side-by-side photographs that show the performance of a SWIR camera (FIG. 9B) under conditions that thwart the performance of a visible camera (FIG. 9A).

Furthermore, device 300 is capable of detecting laser waveband used for target designation and operates at the range of wavelength for which an aircraft canopy is transparent.

While this invention has been particularly shown and described with references to preferred embodiments thereof, it will be understood by those skilled in the art that various changes in form and details may be made therein without departing from the scope of the invention encompassed by the appended claims.

1. A multispectral optical device, comprising:
a common aperture objective assembly for image acquisition in the short wave infrared (SWIR) waveband and at least one additional waveband;
a SWIR detector for detecting an image in the SWIR waveband;
a beam mixer for fusing an image detected by the SWIR detector and an image acquired in the at least one additional waveband;
a first display for displaying an image detected by the SWIR detector; and
a second display for displaying the fused image.

2. The device of claim 1 wherein the at least one additional waveband is visible light waveband.

3. The device of claim 2 further including a first beamsplitter for separating an object beam acquired by the common aperture assembly into a SWIR beam and a visible beam.

4. (canceled)

5. The device of claim 1 wherein the first display is an organic liquid crystal display.

6. The device of claim 1 further including a programmable processor for processing the image detected by the SWIR detector.

7. The device of claim 1, wherein the beam mixer is a second dichroic beamsplitter.

8 The device of claim 7 further including an image intensifier tube for intensifying the visible beam.

9. The device of claim 1 further including a visible waveband detector for detecting an image in the visible waveband.

10. The device of claim 9 wherein the beam mixer includes a programmable processor for processing and fusing images detected by the SWIR detector and the visible waveband detector.

11. The device of claim 10 wherein the second display displays the image fused and processed by the programmable processor.

12. The device of claim 1 wherein said device is helmet-mounted.

13. A night vision system, comprising:
means for acquiring a multi-spectral image through a common aperture;
means for converting a short wave infrared (SWIR) portion of the acquired image into the visible waveband, thereby generating a converted image;
means for fusing the converted image with at least one additional portion of the acquired image;
a first means for displaying the converted image; and
a second means for displaying the fused image.

14. The system of claim 13 further including means for separating the SWIR portion of the acquired image from the visible portion of the acquired image.

15. The system of claim 14 further including means for detecting the SWIR portion of the acquired image.

16. (canceled)

17. The system of claim 13 further including means for intensifying the visible portion of the acquired image.

18. The system of claim 17, wherein the converted image is fused with the intensified visible portion of the acquired image.

19. The system of claim 13 wherein the second means for displaying the fused image displays the visible portion of the acquired image.

20. The system of claim 19 wherein the converted image is fused with the displayed visible portion of the acquired image.

21. A method of displaying images, comprising
acquiring a multi-spectral image through a common aperture;
converting a short wave infrared (SWIR) portion of the acquired image into the visible waveband, thereby generating a converted image;
displaying the converted image on a first display;
fusing the converted image with at least one additional portion of the acquired image; and
displaying the fused image on a second display.

22. The method of claim 21 further including separating the SWIR portion of the acquired image from the visible portion of the acquired image.

23. The method of claim 22 further including detecting the SWIR portion of the acquired image.

24. (canceled)

25. The method of claim 21 further including intensifying the visible portion of the acquired image.

26. The method of claim 25, wherein the converted image is fused with the intensified visible portion of the acquired image.

27. The method of claim 21 further including displaying the visible portion of the acquired image on the second display.

28. The method of claim 27, wherein the converted image is fused with the displayed visible portion of the acquired image.
